(19) United States
(12) Patent Application Publication
(10) Pub. No.: US 2003/0236872 A1
(43) Pub. Date: Dec. 25, 2003

(54) Method and system for enabling electronic transactions via a personal device

(75) Inventor: Paul Atkinson, Poway, CA (US)

Correspondence Address: Truong Dinh, Dinh & Associates, 2506 Ash Street, Palo Alto, CA, 94306, US

(73) Assignee: Kestrel Wireless. Inc., San Diego, CA

(21) Appl. No.: 10/434,676

(22) Filed: May 9, 2003

Related U.S. Application Data
(60) Provisional application No. 60/379,522, filed on May 9, 2002.

(51) Int. Cl. G06F 15/173

(52) U.S. Cl. 709/223

(57) ABSTRACT

A method and system is provided for enabling electronic transactions via a personal device (e.g., a cellular phone). A user initiates a transaction with a second party, both of whom are located in a point-of-presence (POP), by establishing communication between the personal device and a network operations center (NOC). The personal device and NOC communicate via a wide area communication link. The personal device communicates with a POP device for the second party via a local area communication link. The POP device communicates with the NOC via the personal device, which bridges the wide area communication link with the local area communication link. The personal device and POP device provide pertinent information for the transaction to the NOC. The NOC may also access other pertinent information stored for the user and/or the second party. The NOC implements decision rules appropriate for the transaction and provides results for the transaction.

### CROSS-REFERENCES TO RELATED APPLICATIONS

This application claims the benefit of provisional U.S. Application Serial No. 60/379,522, entitled “Method and System for Enabling Electronic Transactions Via Personal Devices,” filed May 9, 2002, which is incorporated herein by reference in its entirety for all purposes.

### BACKGROUND OF THE INVENTION

The present invention relates generally to electronics, and more specifically to a method and system for enabling electronic transactions between a user and a second party present in the same physical location via a personal device.

A person typically encounters numerous transactions in everyday life. Such transactions may be for a purchase of a cup of coffee in the morning, an inquiry for a promotion at a store, and so on. A transaction may require monetary payment. In this case, a person would have to carry cash, a credit card, a checkbook, or some other form of payment to complete the transaction.

It would be highly desirable if one can enable transactions by using a personal device. Such a device may be a cellular phone, an appropriately enabled pager, a personal digital assistant (PDA), and so on. Since personal devices are commonplace nowadays, the ability to effectuate transactions with these personal devices would bring a new level of convenience and security, which would be highly desirable with consumers.

As can be seen, techniques that can enable electronic transactions with a personal device are highly desirable.

### SUMMARY OF THE INVENTION

A method and system is provided herein for enabling electronic transactions via a personal device (e.g., a cellular phone). A user may initiate a transaction with a second party, both of whom are located in a point-of-presence (POP), by establishing communication between the personal device and a network operations center (NOC). The personal device and the NOC communicate via a wide area communication link. The personal device may also communicate with a POP device for the second party via a local area communication link. The POP device can communicate with the NOC via the personal device, which bridges the wide area communication link with the local area communication link.

The personal device and POP device may each provide pertinent information for the transaction directly or indirectly to the NOC. The NOC may also access other pertinent information stored for the user and/or the second party. The NOC implements decision rules appropriate for the transaction and provides results for the transaction, which may be sent to the personal device, the POP device, some other device, or a combination thereof.

A specific embodiment provides a NOC that comprises an input communication unit, an output communication unit, and a processor. The input communication unit receives a first input from a first device (e.g., a personal device) via a first wireless communication link (e.g., the wide area communication link) and a second input from a second device (e.g., a POP device). The second input is initially received by the first device via a second wireless communication link (e.g., the local area communication link) and relayed to the NOC via the first wireless communication link. The processor processes the first and second inputs to effectuate a transaction and provides an output. The output communication unit sends the output for the second device via the first wireless communication link, which is received by the first device and relayed to the second device via the second wireless communication link.

Various other aspects, embodiments, and features of the invention are also provided, as described in further detail below.

### BRIEF DESCRIPTION OF THE DRAWINGS

FIG. 1 shows a system that is capable of facilitating electronic transactions via a personal device;

FIG. 2 shows another representation of the system in FIG. 1;

FIG. 3 shows a system that may be used for a retail store application;

FIG. 4 shows a system that may be used for a home application;

FIG. 5 shows a system that may be used for a drive-thru application;

FIG. 6 shows a system that may be used for a convenience store application;

FIG. 7 shows a process for enabling a particular electronic transaction via a personal device;

FIG. 8 shows a block diagram of a NOC;

FIGS. 9A through 9D show four conventional systems for facilitating electronic transactions; and

FIG. 10 shows a block diagram of a computer system that may be used to implement the NOC.

### DESCRIPTION OF THE SPECIFIC EMBODIMENTS

Terminology

The following terms are used throughout the present application.

A “transaction” is any payment or non-payment activity that is effectuated using decision rules executed at a NOC. Some examples of transactions include transmitting payment or membership information, updating or modifying records or accounts, transferring data or content, book marking or posting media/events/links, sending e-mails, and so on.

A “user” is an individual who is one party to a transaction and is separate and distinct from the other party to the transaction (the second party). A user operates a personal device.

A “second party” is a party or parties involved in the transaction other than the user. The second party is typically a commercial, public, or government entity, but may also be an individual. The second party communicates with the NOC via a wide area communication link provided by the user's personal device.

A “point-of-presence” (POP) is the physical location where the user and second party (i.e., the transacting parties) participate in a transaction process.

A “personal device” is any personal electronic device capable of communicating via a local area communication link and a wide area communication link. Some examples of personal devices include a cellular phone (e.g., a 3 G cell phone), a wired or wireless conventional telephone, an appropriately enabled pager, a personal digital assistant (PDA), a notebook or laptop computer, a specialty terminal (e.g., for order entry, payment, security, data collection, and so on), and other electronic devices. A personal device is used by the user to participate in the transaction process.

A “POP device” is a device located at the POP that provides the second party inputs and is capable of communicating over the local area communication link. A POP device may be an existing device enhanced with a local link interface (e.g., an acoustic or infrared (IR) interface to an existing payment terminal). Some examples of POP devices include a payment processing terminal, a point-of-sale (POS) terminal, a ticketing kiosk, a parking meter, a vending machine, an automated teller machine (ATM), a television, a radio, a personal/home computer, and so on. In some cases more than one POP device may be involved in a single transaction.

A “local area communication link” is an uncoupled communication link for communication between a personal device and a POP device at the POP. Some examples of local area communication links include acoustic or audio, optical, infrared, radio frequency (RF) (e.g., Bluetooth, 802.11x, RFID), and so on. More than one local area communication link may be used during the same transaction.

An “uncoupled communication” is a communication that does not rely upon a wire or cable, tether, or physical (proximate) contact between the personal device and the POP device. In other words, the personal device does not require a behavior/action that equates to physical contact with the POP device.

A “wide area communication link” is a communication link between the personal device and the NOC. The wide area communication link extends beyond the POP and may be wired or wireless. The wide area communication link may be provided by a cellular communication system, a plain old telephone system (POTS), a cable system, a satellite system, and so on, depending on the specific application in which the personal device is used.

A “network operations center” (NOC) is a center where decision rules are implemented to effectuate a transaction. The NOC is located outside of the POP and is accessed via the personal device over the wide area communication link. The functions of the NOC may be distributed over multiple remote locations.

“User inputs” are inputs that may be used to (1) authenticate resources and participants, (2) manage access and retrieval of information, decision rules, and resources, and (3) facilitate the transaction. User inputs may also be used in the transaction itself. For example, user inputs may be for identifiers (IDs), personal identification numbers (PINs), location dependent and transaction specific data, preferences, and so on.

A “user identifier” (user ID) is a unique identifier originated via the personal device that is used by the NOC to identify the user, authorize and regulate access, trigger transactions, and so on. Examples of user IDs include phone numbers, personal device specific identifiers (e.g., serial numbers), user-specific identifiers (e.g., IDs stored in digital wallets, driver license numbers, membership numbers, and so on), and other forms of identification. There may be applications where the ID is acquired automatically (e.g., caller ID).

A “watermark” is a signal having embedded information that may be extracted and used for a transaction. A watermark may be repeated over and over within the same (e.g., audio) signal. More than one watermark may also be included within the same (e.g., audio) signal. For simplicity, the term “watermark” is used herein to refer to both a conventional watermark and a stegnagraphic mark.

System

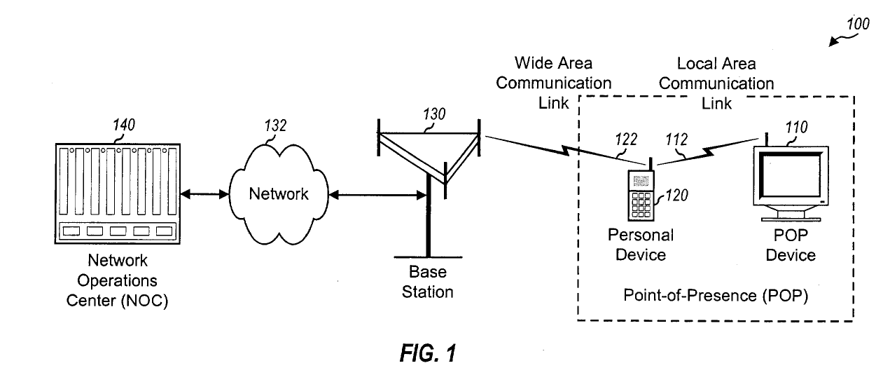

FIG. 1 shows a diagram of a system 100 that is capable of facilitating electronic transactions via a personal device 120. A user engages in a transaction with a second party. The user and second party are both represented at the same physical location, which is referred to as the point-of-presence (POP). System 100 includes the following elements:

Personal device 120—used by the user;

POP device 110—used by the second party;

NOC 140—located outside of the POP, where decision rules are implemented and the transaction is effectuated;

Local area communication link 112—an uncoupled (e.g., RF, infrared, or acoustic) communication link for communication between personal device 120 and POP device 110 in the POP; and

Wide area communication link 122 between personal device 120 and NOC 140 (via base station 130).

The second party's presence in the POP may be realized or manifested by a person, such as a cashier, a security guard, a ticket agent, and so on. The second party's presence in the POP may also be manifested via POP device 110. The second party's presence may also be manifested via media output from POP device 110. The media output may be in the form of a television and/or radio broadcast, streaming Internet media, pre-recorded media such as music and/or movies, and so on.

POP device 110 is an electronic device physically located at the POP and may be stand-alone, free-standing, mobile, or interlinked with local or remote systems. POP device 110 is capable of communicating over one or more types of local area communication links. POP device 110 may be an existing device enhanced with a local area communication link interface (e.g., an acoustic or IR interface to an existing payment terminal). POP device 110 may be as simple as a radio playing music, and the air at the POP can function as an audio local area communication link. Alternatively, POP device 110 may be as complex as a wireless LAN-enabled POS terminal that communicates via an RF local area communication link (e.g., Bluetooth). POP device 110 transmits the second party's inputs to NOC 140. Inputs to POP device 110 may originate at the POP or from a remote location (e.g., radio broadcast, Internet delivery, payment processing system, etc.). POP device 110 communicates with personal device 120 via one or more types of uncoupled local area communication link 112.

The user utilizes personal device 120 to facilitate the transaction with the second party. Personal device 120 may be used to provide user information to NOC 140. Personal device 120 also facilitates communication between POP device 110 and NOC 140 by bridging local area communication link 112 and wide area communication link 122. Some examples of personal device 120 are described above. Different types of personal device 120 may be suitable for different types of system, as described below.

Personal device 120 may provide user inputs, which may be manually entered via a keypad, voice, a touch screen, and so on. Personal device 120 may also provide data unique to the device or the user's communication services, such as the device's serial number or phone number. Personal device 120 may also provide other information that may be stored on the device (e.g., secured information, identification information, user preference, user profile, user selections, and so on).

Personal device 120 communicates with NOC 140 and bridges local area communication link 112 and wide area communication link 122. In some embodiments, personal device 120 only facilitates transport/routing of the communication between POP device 110 and NOC 140 and does not affect the substance of the communication. Personal device 120 effectively determines the particular POP device with which NOC 140 communicates, and the particular NOC with which POP device 110 communicates.

NOC 140 receives user inputs from personal device 120 and second party inputs from POP device 110. NOC 140 then enables the transaction between the user and the second party by performing the necessary processing, which may be dependent on the type of transaction taking place. NOC 140 may send results for the transaction to personal device 120, POP device 110, a third device, or a combination thereof.

A base station 130 facilitates communication between personal device 120 and NOC 140. Base station 130 may communicate with the personal device via wide area communication link 122 and may communicate with NOC 140 via a network 132. Base station 130 may be part of (1) a cellular network (e.g., if personal device 120 is a cellular phone), (2) a public switching telephone network (PSTN) (e.g., if personal device 120 is a conventional phone), (3) a wide area network (WAN) or wide area gateway (e.g., satellite, DSL, cable, T-1, and so on).

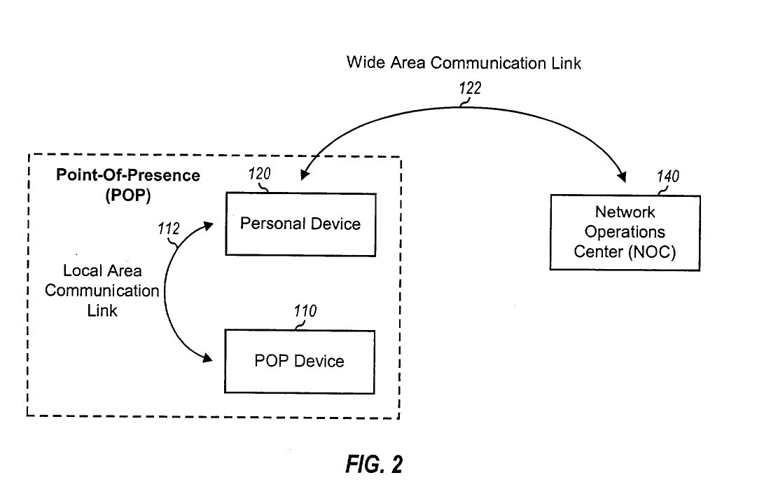

FIG. 2 shows another representation of system 100. Personal device 120 and POP device 110 are both located at the POP and communicate with each other via local area communication link 112. NOC 140 is located outside of the POP.

For many applications, the user initiates a transaction by establishing communication between personal device 120 (e.g., a cellular phone) and NOC 140. For other applications, a transaction may be initiated via other means (e.g., automatically upon occurrence of certain predetermined events).

NOC 140 and personal device 120 communicate via wide area communication link 122. NOC 140 and POP device 110 communicate via personal device 120, which bridges local area communication link 112 and wide area communication link 122. The communication between personal device 120 and NOC 140 may be unsecured and without encryption (e.g., similar to a voice call). For certain types of information, encryption may be used to provide security. The communication may also be encoded to provide increase reliability.

The communication between POP device 110 and NOC 140 may be bi-directional or uni-directional (e.g., from POP device 110 to NOC 140 and/or from NOC 140 to POP device 110). In either case, the communication between POP device 110 and NOC 140 spans both local area communication link 112 and wide area communication link 122. In certain applications, such as one using POTS acoustic communication between POP device 110 and personal device 120, the signal (e.g., sound) travels essentially unaltered between POP device 110 and NOC 140 (or from NOC 140 to POP device 110). In other applications, the signal goes to personal device 120, which then relays it in an equivalent form to its destination (from POP device 110 to NOC 140, or from NOC 140 to POP device 110). In the latter type of applications, personal device 120 acts as a bridge and the content of the communication is minimally altered by the intermediate step even if the format, transport, or protocol changes. For example, packet data may be sent over a 3 G network to personal device 120, which may then send the data via IR to POP device 110.

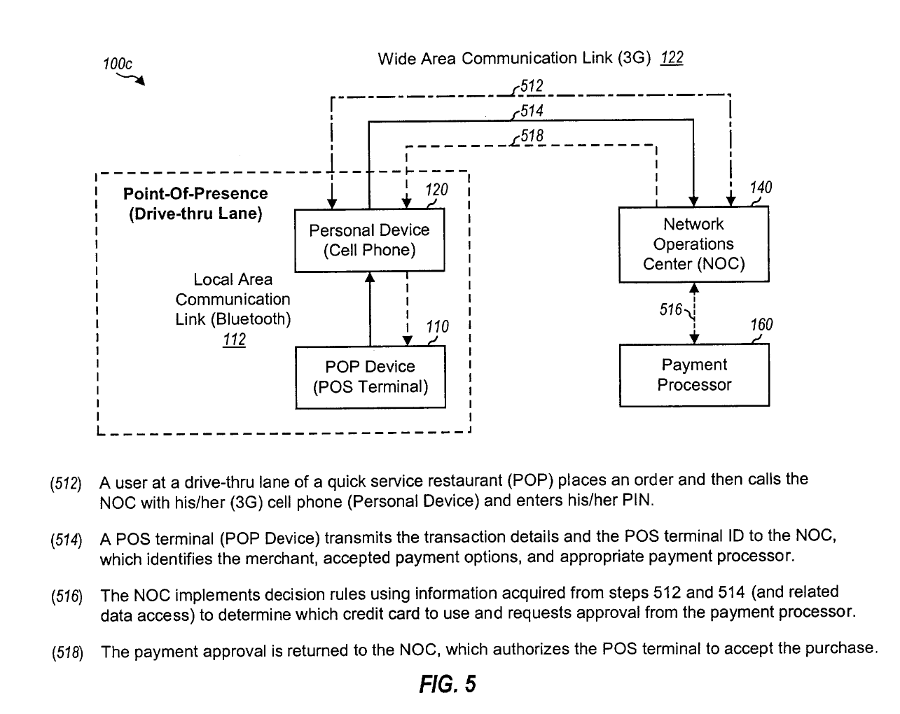

Multiple local area communication links may be used during the same transaction. For example, an acoustic signal may be used to transmit information from POP device 110 to NOC 140 (via personal device 120, which may be a phone) while an IR or RF communication link may be used by personal device 120 to relay information between NOC 140 and POP device 110 (e.g., see FIG. 5).

Communication with NOC 140 may be for the transmission of inputs for a transaction or for other purposes. For example, communication may include outcomes, commands, notifications, and so on, which facilitate the transaction or the outcome of the transaction itself.

NOC 140 executes a transaction by implementing the appropriate decision rules for the transaction. Data and decision rules related to the inputs and necessary to the transaction may be (1) stored at NOC 140 prior to the transaction (e.g., via alternative communication paths such as registration via the Internet), (2) provided by personal device 120 and/or POP device 110, and/or (3) accessible to NOC 140 via some means.

NOC 140 acquires various inputs that are used to manage access and retrieve information and decision rules located at NOC 140 and possibly at other locations. Inputs for the transaction are communicated from the POP to NOC 140 by means of personal device 120 and POP device 110. Additional inputs used for the transaction may be acquired from other sources. NOC 140 may receive various types of inputs, including identification information, authentication information, authorization information, a POP device identifier, selection information, pure data, and other information.

Identification information is used to identify the user or the user's account (e.g., similar to existing voice mail systems). This information may be a cell phone number that may be extracted from the carrier signal or some other information manually entered by the user. Authentication information is used to authenticate the user. This information may be a PIN, which may be manually entered on a cell phone that is used to authenticate the caller. Authorization information may be any information used to authorize the transaction (e.g., a PIN or some other user entered input). A POP device identifier is typically a unique number that is assigned to POP device 110 and used to uniquely identify the POP device. The POP device identifier may be used to ‘look-up’ a database for various types of information related to POP device 110 (e.g., the location and owner of the POP, its promotion partners, and so on).

Selection information may be any information related to choices, selections, options, and so on, related to the transaction and which may be selected by the user. Pure data may be any information related to the transaction (e.g., cost, quantity, and so on). Other information may be additional information such as, for example, an acoustic ‘watermark’ extracted from a radio broadcast that is used to identify a specific promotion and an associated set of decision rules (e.g., to post a link to the user/listener's personal web page).

The inputs received by NOC 140 may be manually entered, previously stored, or dynamically generated during the transaction. Depending on the specific application, the inputs may be provided by personal device 120 and/or POP device 110 at different times, in different order, or simultaneously during the transaction. For example, to complete a particular transaction, a sequence of steps may be performed (possibly in a specific order), and each step may be associated with its own set of inputs used to complete the step.

System 100 shown in FIGS. 1 and 2 may be used for numerous applications. Some exemplary applications are described below. In the following description, the figures show the signal flow as well as the processing performed by various entities to effectuate a specific transaction.

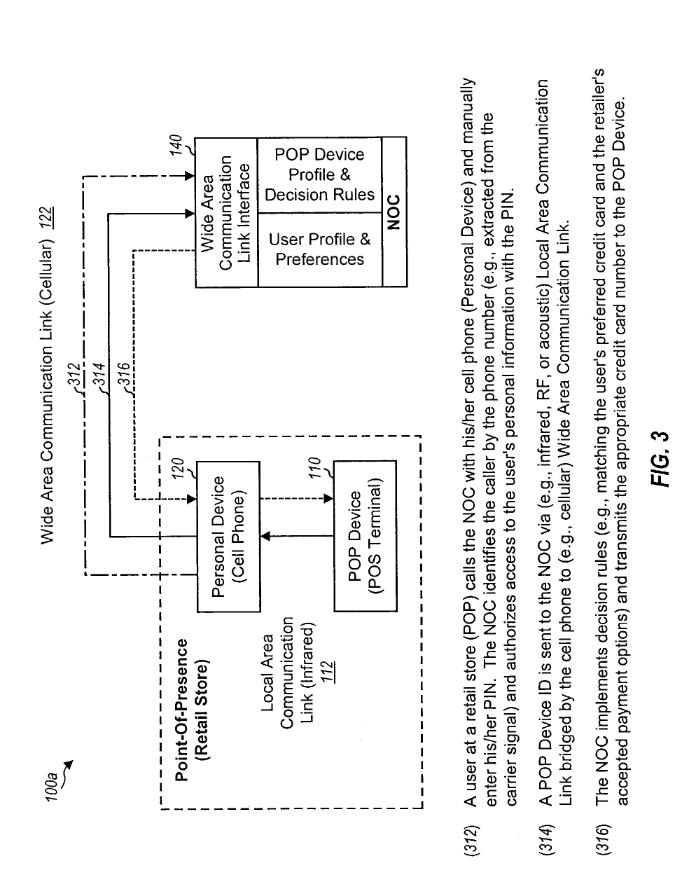

FIG. 3 shows a diagram of a system 100a that may be used for a retail store application. In this embodiment, a user at a retail store (the POP) calls NOC 140 with his/her cell phone (personal device 120) and manually enters the user's PIN (step 312). NOC 140 identifies the user by the phone number, which may be extracted from the carrier signal sent by the cellular phone, and authorizes access to the user's personal information with the PIN (also in step 312). A POS terminal (POP device 110) sends a POP device ID to NOC 140 by transmitting this ID via an infrared, RF, acoustic, or some other link (local area communication link 112) to the cellular phone (step 314). The cellular phone bridges local area communication link 112 with the cellular link (wide area communication link 122) (also in step 314). Upon obtaining all of the required inputs for this transaction, NOC 140 implements the decision rules for the transaction (step 316). For example, the decision rules may indicate matching the user's preferred credit card and the retailer's accepted payment options. NOC 140 then transmits the appropriate credit card information to POP device 110 (also in step 316).

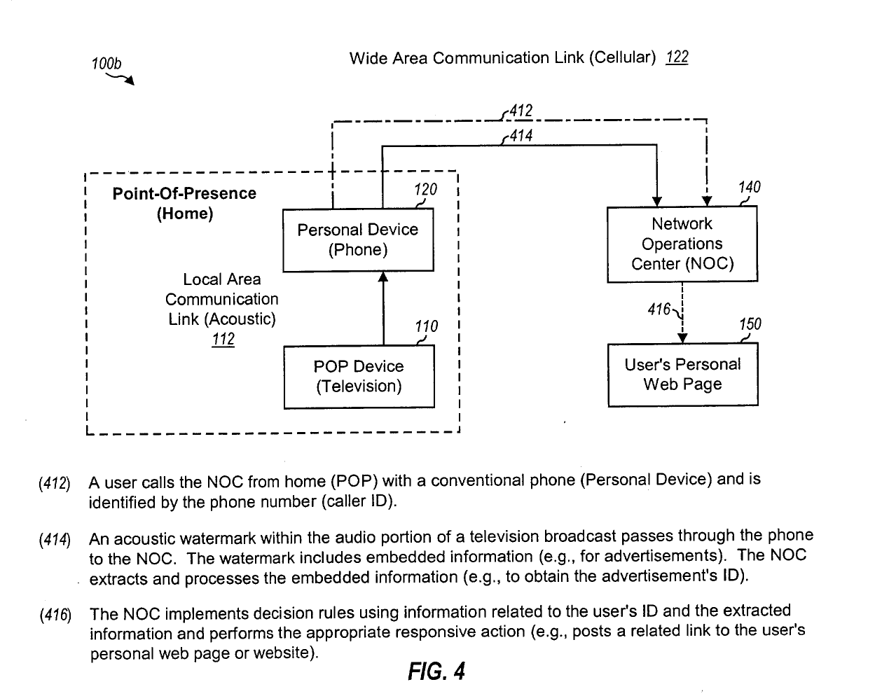

FIG. 4 shows a diagram of a system 100b that may be used for a home application. In this embodiment, a user is watching television in the user's home (the POP). The user calls NOC 140 with a conventional telephone (personal device 120) (step 412). NOC 140 identifies the user by the phone number using caller ID (also in step 412). An acoustic watermark within the audio portion of the television broadcast passes through the phone to NOC 140 (step 414). The watermark includes embedded information that may be used, for example, to associate the broadcast to specific advertisements. NOC 140 extracts and processes the embedded information and obtains, for example, the advertisement's ID (also in step 414). NOC 140 implements the decision rules using information related to the user's ID and the extracted information and performs appropriate responsive action (step 416). For example, the decision rules may direct NOC 140 to post a related link to the user's personal website 150.

FIG. 5 shows a diagram of a system 100c that may be used for a drive-thru application. In this embodiment, a user at a drive-through lane of a quick service restaurant (the POP) places his/her order. The user then calls NOC 140 with a 3 G cell phone (personal device 120) and enters the user's PIN (step 512). NOC 140 identifies the user by the phone number, which may be extracted from the carrier signal sent by the cellular phone, and authorizes access to the user's personal information with the PIN (also in step 512). A POS terminal (POP device 110) sends the transaction details and the POS terminal ID to NOC 140 (via the 3 G cell phone, which bridges local area communication link 112 with wide area communication link 122) (step 514). NOC 140 identifies the merchant, the accepted payment options, and the appropriate payment processor, which may be associated with the POS terminal ID (also in step 514).

NOC 140 then implements the decision rules for the transaction using the information obtained from the 3G cell phone in step 512, information obtained from the POS terminal in step 514, and other information accessed by NOC 140 to determine which credit card to use and requests payment approval from a payment processor 160 (step 516). Upon obtaining an approval from payment processor 160, NOC 140 authorizes the POS terminal to accept the purchase (step 518).

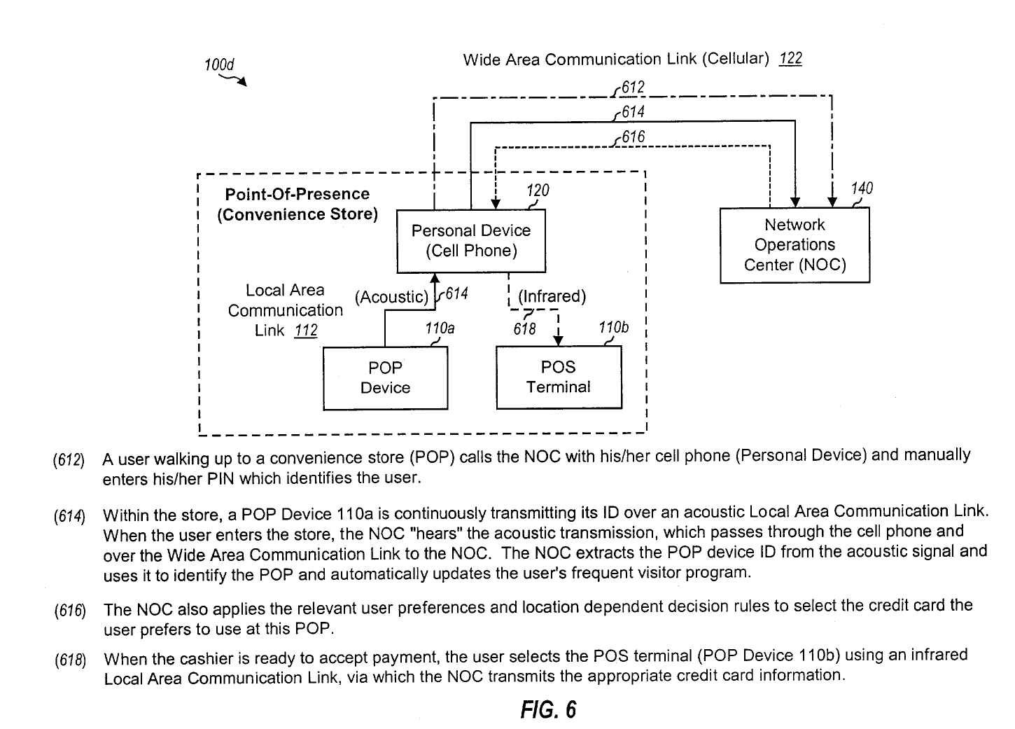

FIG. 6 shows a diagram of a system 100d that may be used for a convenience store application. In this embodiment, a user walking up to a convenience store (POP) calls NOC 140 with a cellular phone (personal device 120) and manually enters the user's PIN (step 612). NOC 140 identifies the user by the PIN number (also in step 612).

Within the store, a POP device 110a is continuously transmitting its ID over an audible or inaudible acoustic local area communication link 112a (step 614). When the user enters the store, the acoustic transmission from POP device 110a is picked up by the user's cellular phone and sent via the cellular wide area communication link 122 to NOC 140 (also in step 614). NOC 140 thus “hears” the acoustic transmission from POP device 110a (also in step 614). NOC 140 extracts the ID of POP device 110a from the acoustic transmission and uses it to identify the POP. NOC 140 may automatically update the user's frequent visitor program for the store. NOC 140 may also apply the relevant user preferences and location dependent decision rules to select the credit card that the user prefers to use at this store (step 616). When the cashier is ready to accept payment, the user selects a POS terminal (POP device 110b) using an infrared local area communication link 112b (step 618). NOC 140 is informed of the selected POP device 110b and transmits the appropriate credit card information via the same infrared local area communication link 112b (also in step 618).

The method and system described herein may also be used for other applications. For example, a local radio station may broadcast a promotion containing an audible or inaudible acoustic watermark. A user listening to the broadcast in the user's car may call NOC 140 with the user's cellular phone. The radio broadcast over the car radio's speakers is carried in a perceptually equivalent form through the cellular phone to NOC 140. Using the cell phone number and information contained in the watermark, NOC 140 can automatically route the user's call to the promoter's designated call center.

As another example, a guest at an amusement park may securely pass a pre-paid electronic ticket directly to an automated attendant (POP device 110) by calling NOC 140 from a cell phone (personal device 120) and manually entering the guest's user ID or PIN. The automated attendant's ID is transmitted via infrared to the cell phone, which relays it over a wireless packet switched network to NOC 140. NOC 140 authenticates the user and applies the appropriate decision rules to authorize admittance. On the reverse path (e.g., via a 3 G network between the cell phone and NOC 140 and an IR link between the cell phone and POP device 110), NOC 140 communicates the authorization code to the automated attendant, which admits the guest.

In general, different applications may be associated with:

a) different types of personal device;

b) different types of local and wide area communication links;

c) different types of transaction being performed; and

d) different types of inputs being sent to the NOC.

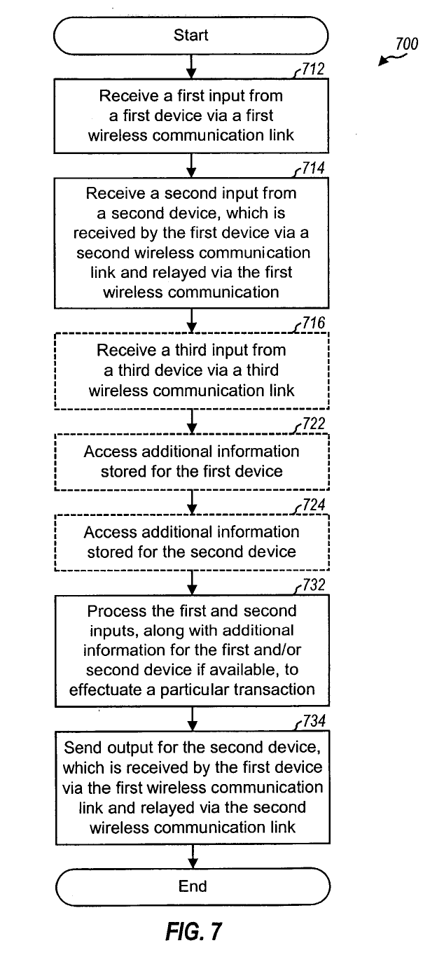

FIG. 7 shows a flow diagram of a process 700 for enabling a particular electronic transaction via a personal device. Process 700 may be performed by the NOC. In the following description for FIG. 7, steps that are not appropriate for some applications are indicated by dashed boxes.

Initially, a first input is received from a first device (a personal device) via a first wireless communication link (a wide area communication link) (step 712). The first input may include multiple pieces of information (or multiple inputs) from the first device. The first input may comprise identification information for the first device, user authentication information, information related to the particular transaction, and so on. The first device identification information may be, for example, a phone number extracted from a signal transmitted by the first device, an ID manually entered at the first device, and so on. As used herein, an ID may include any alphanumeric number assigned for that purpose and not just cell phone numbers. The user authentication information may be, for example, a PIN. The transaction related information may include, for example, one or more user selections for options available for the particular transaction (e.g., press “1” to use your default card, press “2” to . . . ), credit card information, and so on.

A second input is also received from a second device (a POP device) (step 714). The second input is initially received by the first device via a second wireless communication link (a local area communication link) and then relayed to the NOC via the first wireless communication link. The second input from the second device may comprise identification information for the second device, information related to the particular transaction, and so on.

A third input may also be received from a third device (step 716). The third input is received by the first device via a third wireless communication link and relayed to the NOC via the first wireless communication link. The third input may comprise an acoustic watermark, information that identifies a specific transaction and an associated set of decision rules to be used to effectuate the specific transaction, and so on.

Additional information stored for the first device may also be accessed (step 722). This information may be identified by identification information for the first device (e.g., the phone number extracted from the signal transmitted by the first device). The additional information for the first device may comprise user profile and preference information, secured information to be used for the particular transaction (e.g., credit card information), information related to valued assets applicable for the particular transaction, and so on. The valued assets may include tickets, coupons, prizes, awards, script, ‘points’, other representations, or any combination thereof.

Additional information stored for the second device may also be accessed (step 724). This information may be identified by identification information for the second device (e.g., POP device ID, which may be included in the second input). The accessed information for the second device may comprise device profile information, decision rules applicable for the second device, and so on.

The first and second inputs are processed to effectuate the particular transaction (step 732). The accessed information for the first and/or second devices, if any, is also used to effectuate the particular transaction. The processing may be based on a set of decision rules, which may be stored at the NOC or provided to the NOC.

An output for the transaction is sent for the second device via the first wireless communication link (step 734). The output is received by the first device via the first wireless communication link and relayed to the second device via the second wireless communication link. The output is dependent on the type of transaction being performed. The particular transaction may be effectuated, for example, by (1) sending payment information, if the particular transaction relates to a purchase, (2) sending an authorization for the purchase, (3) updating an account maintained for the first device based on the first and second inputs, (4) posting a related link to a Web account associated with the first device, (5) sending an output for the first device via the first wireless communication link, (6) initiating an event at an electronic destination associated with the first device, (7) initiating another event at an electronic destination associated with the second device, and so on.

Payment information may be determined based on the first and second inputs and a set of decision rules available to the NOC. The payment information may include a particular form of payment to be used for the purchase (e.g., non-cash payment, debit cards, pre-paid cards, checks, and so on), credit card information, and so on.

The responsive action by the NOC may thus include a communication to the first device (e.g., a voice response—“you won the prize”), a communication with an electronic destination associated with the first device (e.g. web page, e-mail address etc.), a communication with an electronic destination associated with the second device, and so on. The electronic destination may be an electronic account (e.g., web page, e-mail address) or a physical device.

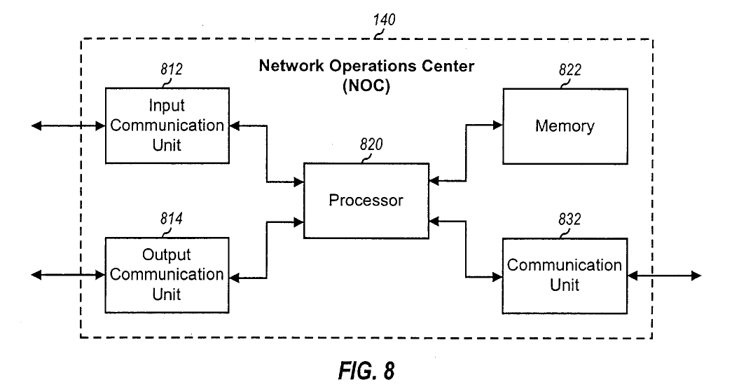

FIG. 8 shows a block diagram of an embodiment of NOC 140. In this embodiment, NOC 140 includes an input communication unit 812 that receives a first input from a first device (e.g., personal device 120) via a first wireless communication link (e.g., wide area communication link 122). Input communication unit 812 also receives a second input from a second device (e.g., POP device 110) via the first and a second wireless communication link (e.g., local area communication link 112). To facilitate the transaction, NOC 140 may further comprise a communication unit 832 used to access information stored for the first device and information stored for the second device.

A processor 820 processes the first and second inputs and possibly other information based on decision rules applicable for a transaction to effectuate the transaction. An output communication unit 814 sends an output for the second device via the first wireless communication link. The output is received by the first device and relayed to the second device via the second wireless communication link. Memory unit 822 stores data and program codes for processor 820.

The method and system comprise the following features.

NOC 140 processes data (performs a transaction) based on inputs from two devices received via one communication link, which is established through the personal device. This communication link has the following features: (a) the communication link with NOC 140 is unique to one of the devices (the personal device), and/or (b) there are two types of communication links involved (local and wide area), and/or (c) there is one communication link for the communication between the personal device and the NOC, and two communication links for the communication between the POP device and the NOC—one of which is the same as that used for communication between the personal device and the NOC.

Personal device 120 acts as an intermediary for communication between two devices via two different communication links to facilitate a transaction. There are multiple parties to the transaction. One party acts as an intermediary for communication between the other two, and this party acts as an I/O device (participates in the transaction beyond being a communication relay). This party is not the site of the transaction. The communication links include both wide area and local area (the proximate relationship between the personal device and the POP device, and their remote location from the site of the transaction addresses).

Personal device 120 concurrently communicates with multiple devices (NOC 140 being one of the devices) over different communication links for a transaction

An acoustic link may be used to send information for a transaction.

A watermark or a stegnagraphic encoding may be used with broadcast data for POP device 110. An acoustic watermark or stegnagraphic encoding may be embedded in, or concurrently or sequentially transmitted with, an audio broadcast via a phone (wired or wireless) to NOC 140. NOC 140 then extracts the acoustic watermark or stegnagraphic encoding to facilitate a transaction. An acoustic watermark or stegnagraphic encoding may also be used with a personal electronic device capable of deciphering/extracting the code. This feature may be used in various applications (e.g., a TV remote control, security device, and so on) once the personal devices are equipped with more processing power and memory.

The method and system may be used to perform a secured transaction based on authentication information received via an unsecured wireless link and stored secured information. The method and system may also be used to authorize access to information (and/or transaction) by proxy.

The method and system has the following unique attributes. First, the transaction depends on, but is not limited to, (1) decision rules applied outside the POP (at NOC 140) and (2) inputs obtained from both the POP device and the personal device. Second, the POP device and the personal device communicate with the NOC over a wide area communication link in the same session or call, as opposed to two separate communications (two different cell phone calls) with the NOC for the POP device and the personal device over the same type of link. Third, the POP device and the personal device communicate with the NOC over the same wide area communication link. Fourth, communication between the NOC and the POP device pass through, or are relayed by, the personal device. Fifth, the personal device does not need transaction or application specific enabling hardware or software. Special hardware and/or software applications like digital wallets, inventory tracking, or payment software are not needed to effectuate the transaction. The personal device only needs to include the proper components used to communicate with the NOC and POP device such as speakers, modems, IR/RF transmitters/receivers, a general-purpose interface equivalent to an Internet browser, and so on. Sixth, the personal device need not be physically connected or tethered to the POP device. They are distinct and separate devices.

An aspect of the disclosed method and system is that the “application” is disintermediated from the personal device and the POP device. In other words, it works like the Internet with a generic I/O client (Browser) separate from the server-side/NOC application (web site).

In one embodiment of the system and method, the personal device does not have any application specific software or hardware. In other words, the personal device comprises an I/O device plus a relay medium (between the POP device and the NOC). This embodiment would embrace the use of a Browser. The system and method may be supplemented with additional application-specific code on the personal device. This code may be permanently stored on the personal device or may be provided as necessary, e.g., temporarily for single use.

In another embodiment, the system and method comprises a combination of (1) the location of the decision rules (at the NOC versus the POP device) and (2) a requirement that inputs from both the POP device and the personal device be used in the transaction. It may be difficult to define where the inputs originate within the POP. In other words, an input from the POP device may be relayed directly to the NOC, or the same input may be captured by the personal device and then relayed to the NOC via its own application.

The method and system described herein addresses many of the problems that limit electronic transactions at the POP by removing barriers to participation and intermediating between the multitude of different devices, communication systems, and applications. The method and system offers many advantages. First, personal devices such as phones do not need special or not readily available transaction-enabling features or capabilities. Second, applications and services can be developed independently of the personal device. Third, transactions may be executed without a separate telecommunication channel at the POP since the local area communication link between the personal device and the POP device is uncoupled. Fourth, transactions can be executed using existing transaction devices/systems (e.g., credit card terminals, POS terminals, etc.) with the addition of inexpensive communication interfaces/devices. Fifth, everyday appliances such as televisions or radios can function as POP devices.

The method and system described herein has many applications, only some of which are described above. For example, the method and system may be used to make a purchase at a store by contacting a remote entity with the personal device, sending it secure personal ID information, and having the entity effect the purchase. The user would no longer need to carry cash, a credit card, or a checkbook. The method and system may be used to pay an automated parking meter or a vending machine, and would obviate the need to carry the appropriate change. The method and system may also be used at an automated ticket kiosk to purchase a ticket or to confirm the purchase of a pre-paid electronic ticket. The method and system may be used to enable a purchase in the drive-thru lane of a fastfood restaurant during the night in the safety of one's car.

In addition to facilitating business/financial transactions, the method and system may be used for inquiries about a product or service. A ubiquitous device like a TV or radio can broadcast an advertisement, and an acoustic watermark may be included in the broadcast signal to identify the advertisement. The personal device may be used to relay the broadcast signal to a remote entity, which can connect the user to an associated call center or send pertinent links to the user's personal Web page.

The method and system enables many different types of transactions with a personal device in a convenient and secure way. The method and system utilizes existing communication links and networks and the personal device. The devices at the site of transaction do not require special or not readily available transaction-enabling features.

Differentiation

In contrast to the method and system described herein, conventional systems have several limitations that restrict their use. Some of these conventional systems are described below.

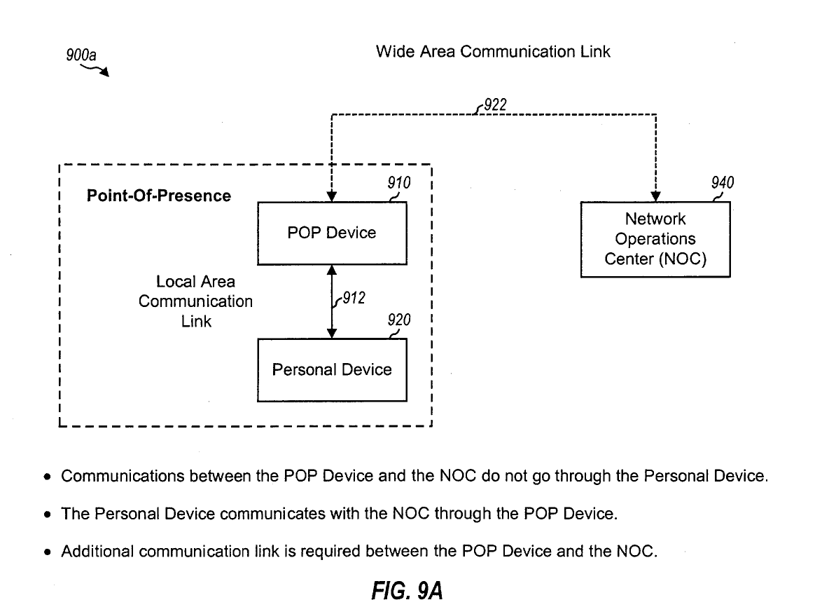

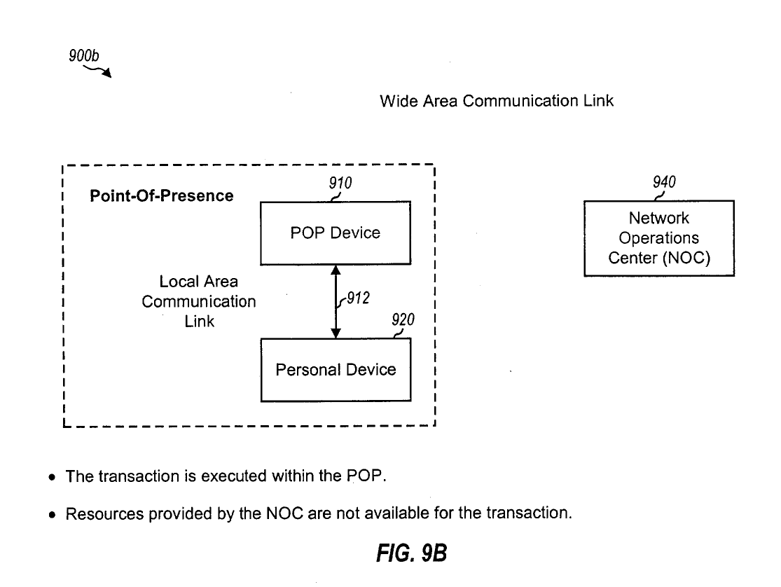

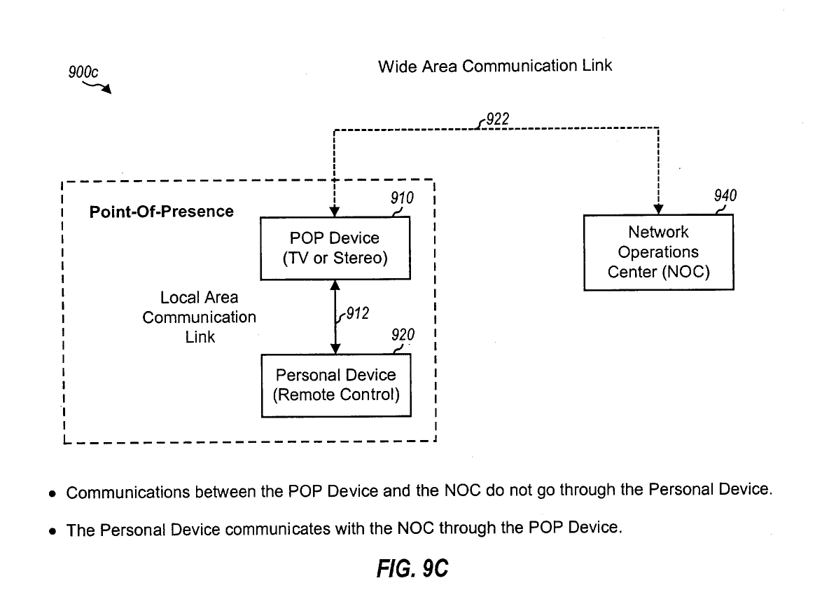

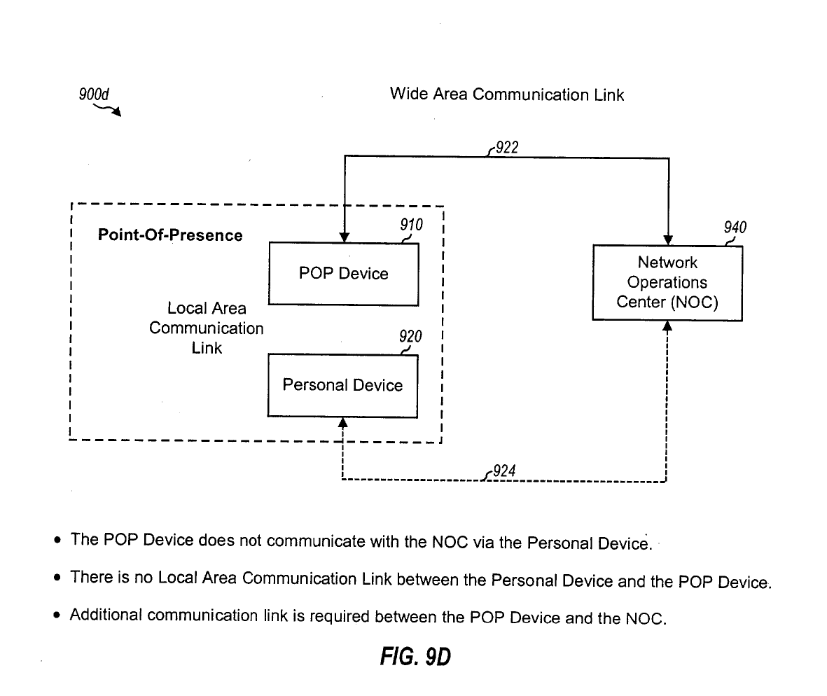

FIG. 9A shows a conventional system 900a whereby a POP device 910 communicates directly with a NOC 940. POP device 910 communicates with a personal device 920 via a local area communication link 912. POP device 910 further communicates with NOC 940 via a wide area communication link 922. Communication between POP device 910 and NOC 940 does not go through personal device 920. Personal device 920 communicates with NOC 940 via POP device 910.

System 900a is a wireless payment model that uses “digital wallets” in conjunction with remote payment authorization systems. For example, a credit card number stored in the digital wallet of a next generation cell phone (personal device 920) is transmitted over an infrared local area communication link directly to a credit card terminal (POP device 910), which then sends the information to a remote processing center (NOC 940) for approval. For system 900a, communication between personal device 920 and NOC 940 are relayed through POP device 910. Personal device 920 implements decision rules related to the transaction (e.g., the exchange of payment information). Personal device 920 is not required to communicate over the local area communication link. POP device 910 requires transaction enabling hardware and/or software. Moreover, a communication link is required between POP device 910 and NOC 940.

FIG. 9B shows a conventional system 900b whereby NOC 940 is not used to execute transactions. POP device 910 communicates with personal device 920 via local area communication link 912. The transaction is executed within the POP. Resources provided by NOC 940 are not available for the transaction. System 900b is a wireless payment scheme that uses a “stored value” or digital wallet without remote payment authorization systems. For this scheme, there is neither a NOC nor a wide area communication link. Personal device 920 implements decision rules related to the transaction (e.g., the exchange of payment information), the transaction is executed within the POP, and personal device 920 is not required to communicate over the local area communication link. For example, a payment is made by transferring the payment or “value” directly from a PDA (personal device) over a local area communication link to the POS terminal (POP device).

FIG. 9C shows a conventional system 900c with a TV or stereo (POP device 910) and remote control (personal device 920). In system 900c, communication between the personal device and the NOC is relayed through the POP device. Communication between the POP device and the NOC does not go through the personal device.

FIG. 9D shows a conventional system 900d whereby communication between personal device 920 and POP device 910 goes from personal device 920 over a wide area communication link 924 to NOC 940, and then from NOC 940 via a different wide area communication link 922 to POP device 910. As an example, a user at a gas station (POP) calls NOC 940 with his/her cell phone (personal device 920) and enters the POS terminal ID on the phone's keypad. NOC 940 uses the terminal ID to identify the POS terminal (POP device 910), accesses related information, and communicates it over an Internet or wireless connection (i.e., the wide area communication link). For system 900d, communication between POP device 910 and NOC 940 is not relayed through personal device 920. Communication between POP device 910 and NOC 940 is not relayed over the same wide area communication link as that between personal device 920 and NOC 940. An additional communication link is required between POP device 910 and NOC 940.

The method and system described herein is also different from an inventory system whereby the personal device is used to update an inventory system by reading bar codes. For this inventory system, the personal device uses resident software and hardware applications specific to the transaction (e.g. bar code reader). The bar codes are not an electronic POP device. There is no direct communication between the POP device and the NOC.

Computer System

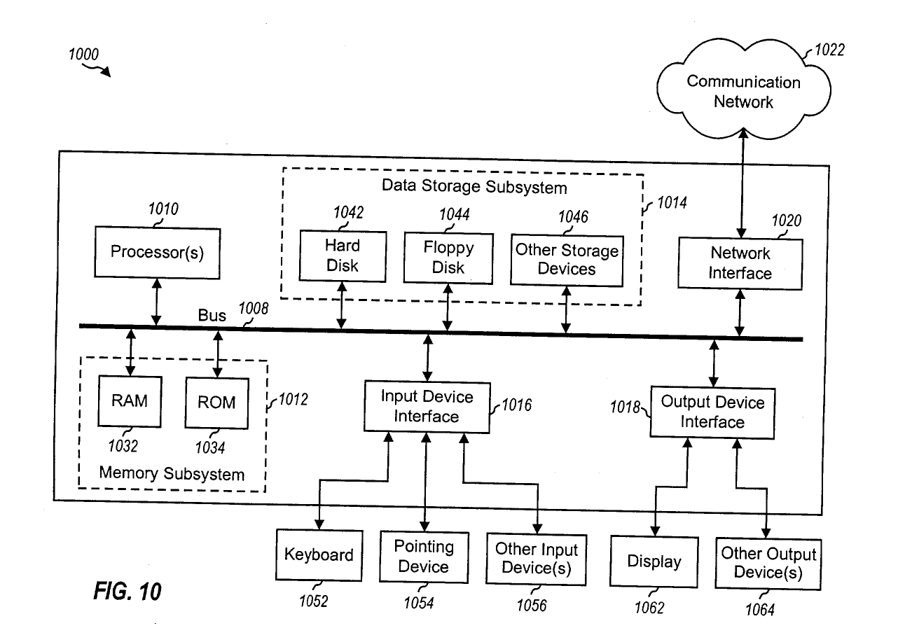

FIG. 10 shows a block diagram of a computer system 1000 that may be used to implement the NOC. The personal device and POP device may each also be implemented with a different or simplified version of system 1000. System 1000 includes a bus 1008 that interconnects major subsystems such as one or more processors 1010, a memory subsystem 1012, a data storage subsystem 1014, an input device interface 1016, an output device interface 1018, and a network interface 1020. Processor(s) 1010 perform many of the processing functions for system 1000 and communicate with a number of peripheral devices via bus 1008.

Memory subsystem 1012 may include a RAM 1032 and a ROM 1034 used to store codes and data that implement various aspects of the invention. In a distributed environment, the program codes and data may be stored on a number of computer systems and used by the processors of these systems. Data storage subsystem 1014 provides non-volatile storage for program codes and data, and may include a hard disk drive 1042, a floppy disk drive 1044, and other storage devices 1046 such as a CD-ROM drive, an optical drive, and removable media drive.

Input device interface 1016 provides an interface with various input devices such as a keyboard 1052, a pointing device 1054 (e.g., a mouse, a trackball, a touch pad, a graphics tablet, a scanner, or a touch screen), and other input device(s) 1056. Output device interface 1018 provides an interface with various output devices such as a display 1062 (e.g., a CRT or an LCD) and other output device(s) 1064. Network interface 1020 provides an interface for system 1000 to communicate with other devices coupled to communication network 1022. For simplicity, only one network interface 1020 is shown in FIG. 10. Multiple network interfaces (possibly for different types of communication links) may also be provided and used for communication with different devices.

Many other devices or subsystems (not shown) may also be coupled to system 1000. In addition, it is not necessary for all of the devices shown in FIG. 10 to be present in order to practice the invention. Furthermore, the devices and subsystems may be interconnected in configurations different from that shown in FIG. 10. One or more of the storage devices may be located at remote locations and coupled to system 1000 via communication network 1022. The operation of a computer system such as that shown in FIG. 10 is readily known in the art and not described in detail herein. The source codes to implement certain embodiments of the invention may be operatively disposed in memory subsystem 1012 or stored on storage media such as a hard disk, a floppy disk, or a CDROM that is operative with a CD-ROM player.

Headings are included herein for reference and to aid in locating certain sections. These headings are not intended to limit the scope of the concepts described therein under, and these concepts may have applicability in other sections throughout the entire specification.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A network operations center (NOC) comprising:
means for receiving a first input from a first device via a first wireless communication link;
means for receiving a second input from a second device, wherein the second input is initially received by the first device via a second wireless communication link and relayed to the NOC via the first wireless communication link;
means for processing the first and second inputs to effectuate a particular transaction; and
means for sending an output for the second device via the first wireless communication link, wherein the output is received by the first device and relayed to the second device via the second wireless communication link.

2. The NOC of claim 1, wherein the first input from the first device comprises identification information for the first device, and wherein the particular transaction is further effectuated based on the first device's identification information.

3. The NOC of claim 1, wherein the first input from the first device comprises user authentication information.

4. The NOC of claim 1, wherein the first input from the first device comprises information related to the particular transaction.

5. The NOC of claim 1, further comprising:
means for accessing information stored for the first device, and
wherein the particular transaction is further effectuated based on the accessed information for the first device.

6. The NOC of claim 1, wherein the second input from the second device comprises identification information for the second device.

7. The NOC of claim 1, wherein the second input from the second device comprises information related to the particular transaction.

8. The NOC of claim 1, further comprising:
means for accessing information stored for the second device, and
wherein the particular transaction is further effectuated based on the accessed information for the second device.

9. The NOC of claim 1, further comprising:
means for receiving a third input from a third device, wherein the third input is received by the first device via a third wireless communication link and relayed to the NOC via the first wireless communication link, and
wherein the first, second, and third inputs are processed to effectuate the particular transaction.

10. The NOC of claim 9, wherein the third input from the third device comprises an acoustic watermark.

11. The NOC of claim 9, wherein the third input from the third device identifies a specific transaction and an associated set of decision rules to be used to effectuate the specific transaction.

12. The NOC of claim 1, further comprising:
means for accessing information stored for the first device;
means for accessing information stored for the second device, and
wherein the first and second inputs and the accessed information for the first and second devices are processed based on a set of decision rules available to the NOC.

13. The NOC of claim 12, wherein the decision rules are stored at the NOC.

14. The NOC of claim 12, wherein the decision rules are provided to the NOC via the first wireless communication link.

15. The NOC of claim 1, wherein the first device is a wireless terminal.

16. The NOC of claim 1, wherein the second device is a point-of-presence (POP) device.

17. The NOC of claim 1, wherein the second device is a point-of-sale (POS) terminal.

18. The NOC of claim 1, wherein the first wireless communication link is a wide area communication link.

19. The NOC of claim 1, wherein the second wireless communication link is a local area communication link.

20. A method of effectuating an electronic transaction, comprising:
receiving a first input from a first device via a first wireless communication link;
receiving a second input from a second device, wherein the second input is initially received by the first device via a second wireless communication link and relayed to the NOC via the first wireless communication link;
processing the first and second inputs to effectuate the transaction; and
sending an output for the second device via the first wireless communication link, wherein the output is received by the first device and relayed to the second device via the second wireless communication link.

21. A network operations center (NOC) comprising:
an input communication unit operative to receive a first input from a first device via a first wireless communication link and a second input from a second device, wherein the second input is initially received by the first device via a second wireless communication link and relayed to the NOC via the first wireless communication link;
a processor operative to process the first and second inputs to effectuate a particular transaction; and
an output communication unit operative to send an output for the second device via the first wireless communication link, wherein the output is received by the first device and relayed to the second device via the second wireless communication link.
